(19) United States
(12) Patent Application Publication
(10) Pub. No.: US 2017/0221164 A1
(43) Pub. Date: Aug. 3, 2017

(54) DETERMINING COURSE NEED BASED ON MEMBER DATA

(71) Applicant: Linkedln Corporation, Mountain View, CA (US)

(72) Inventors: John Phillip Loof, San Francisco, CA (US); Christopher Wright Lloyd, II, New York, NY (US); Danielle Leigh Kennedy, Pacifica, CA (US); Link Gan, San Francisco, CA (US)

(21) Appl. No.: 15/010,781

(22) Filed: Jan. 29, 2016

(51) Int. Cl. G06Q 50/20; G06Q 10/10; G06Q 50/00

(52) U.S. Cl. CPC G06Q 50/2057; G06Q 50/01; G06Q 10/1053

(57) ABSTRACT

System and methods for determining course need based on member data are disclosed. For a respective skill in a list of skills, a server system determines a member interest score in the respective skill. The server system then determines an employer interest score in the respective skill. The server system determines a number of courses available for the respective skill at a server system. The server system generates a content priority score for the respective skill in the list of skills based on the member interest, the employer interest, and the number of skill learning materials associated with the skill.

### TECHNICAL FIELD

The disclosed example embodiments relate generally to the field of social networks and, in particular, to personalizing career recommendations.

### BACKGROUND

The rise of the computer age has resulted in increased access to personalized services online. As the cost of electronics and networking services drops, many services can be provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly.

Another service provided over networks is social networking services. Large social networks allow members to connect with each other and share information. One such type of information is information about members' jobs, careers, education, and goals. Social networks enable members to share and view information about their careers and skills. Using that information, a social network can provide learning and employment opportunities.

### DESCRIPTION OF THE DRAWINGS

Some example embodiments are illustrated by way of example and not limitation in the figures of the accompanying drawings, in which:

FIG. 1 is a network diagram depicting a client-server system that includes various functional components of a server system, in accordance with some example embodiments.

FIG. 2 is a block diagram illustrating a client system, in accordance with some example embodiments.

FIG. 3 is a block diagram illustrating a server system, in accordance with some example embodiments.

FIG. 4 depicts a block diagram of an exemplary data structure for the member profile data for storing member profiles in accordance with some example embodiments.

FIG. 5 is a flow diagram illustrating a method, in accordance with some example embodiments, for generating content generation recommendations based on a demand and supply analysis of skills.

FIGS. 6A-6C is a flow diagram illustrating a method, in accordance with some example embodiments, for generating content generation recommendations based on a demand and supply analysis of skills.

FIG. 7 is a block diagram illustrating an architecture of software, which may be installed on any one or more of devices, in accordance with some example embodiments.

FIG. 8 is a block diagram illustrating components of a machine, according to some example embodiments.

Like reference numerals refer to corresponding parts throughout the drawings.

### DETAILED DESCRIPTION

The present disclosure describes methods, systems, and computer program products for providing improved job listing information for members. In the following description, for purposes of explanation, numerous specific details are set forth to provide a thorough understanding of the various aspects of different example embodiments. It will be evident, however, to one skilled in the art, that any particular example embodiment may be practiced without all of the specific details and/or with variations, permutations, and combinations of the various features and elements described herein.

In some example embodiments, a server system (e.g., a server system that provides a social networking service) can provide one or more skill learning courses. In some example embodiments, the skill learning courses are network delivered video courses that are made available to members of the server system either as part of their membership with the server system or for an additional fee. However, as technology improves, demand for skill learning courses changes and increases as new or different skills become relevant in the job market.

With finite resources to produce new skill learning courses, the server system must determine which skill learning courses will bring the most value to the members of the server system. The server system thus analyzes each skill or skill cluster (e.g., a group of closely related skills) to generate a content priority score for that skill or skill cluster. The higher the content priority skill, the greater the incentive for the server system to produce additional skill learning material for that skill or skill cluster.

In determining a content priority score for a particular skill or skill cluster, the server system first determines the level of demand for that skill. The terms interest and demand may be used interchangeably in the text of this disclosure. In some example embodiments, the server system stores or has access to a large number of current job listings. Each job listing includes a list of requirements. The server system analyzes the requirements of each job listing to determine a list of required skills for that job.

Once all the job listings have been analyzed, the server system is able to determine which skills are the most commonly required for current job listings. In some example embodiments, the server system also stores data about the most required skills in the past. Using past job requirement data, the server system can determine trends in skill requirement for jobs.

In some example embodiments, the server system also determines, for each respective skill or skill cluster, the number of members who have that respective skill. In some example embodiments, the server system also analyzes the new hires or job changes to determine which skills are the most common for newly hired workers.

In some example embodiments, the server system also accesses search information for a particular time period. In some example embodiments, the accessed search information includes all the terms searched by users during a given period of time and their relative frequency. The server system uses the relative search frequency of terms associated with each skill or skill cluster to estimate member interest in each of the skills or skill clusters.

The server system also determines, for each skill or skill cluster, the number of skill learning materials currently available through the server system. Each skill or skill cluster is given a score representing the amount and quality of the skill learning material for each skill.

The server system then generates an overall content priority score for each skill or skill cluster by comparing estimated member demand (e.g., based on skill listings, member skill profiles, job change records, and member search histories) to the current available content score for that particular skill or skill cluster. Skills with more member interest or demand and less already produced skill learning material are given a high content priority score, such that producing content for learning those skills are more likely to occur.

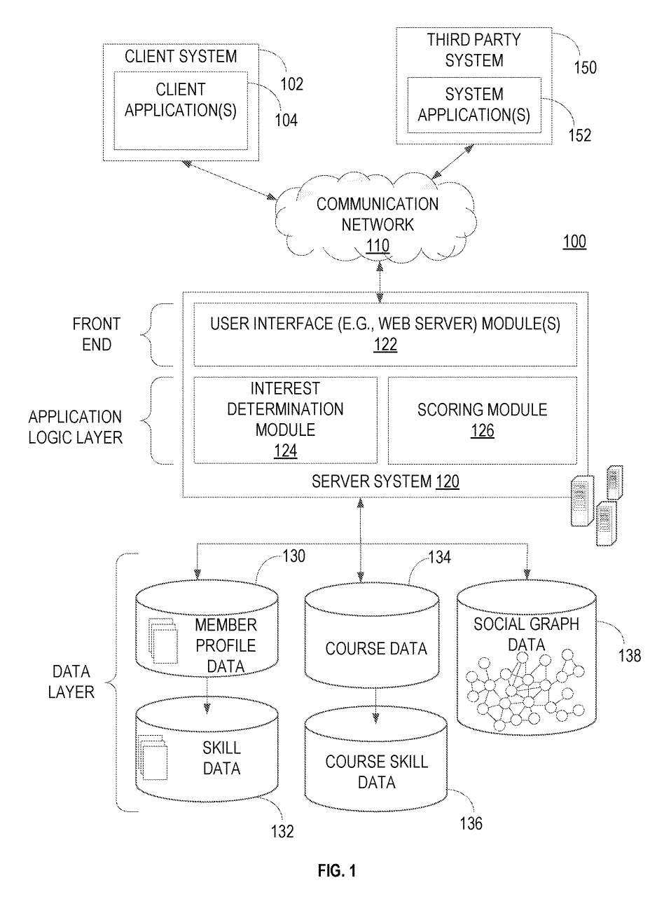

FIG. 1 is a network diagram depicting a client-server system environment 100 that includes various functional components of a server system 120, in accordance with some example embodiments. The client-server system environment 100 includes one or more client systems 102 and a server system 120. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser. The client system 102 uses a web browser to send and receive requests to and from the server system 120 and displays information received from the server system 120.

In some example embodiments, the client system 102 includes an application specifically customized for communication with the server system 120 (e.g., a LinkedIn iPhone application). In some example embodiments, the server system 120 is a server system that is associated with one or more services.

In some example embodiments, the client system 102 sends a request to the server system 120 for a webpage associated with the server system 120. For example, a member uses a client system 102 to log into the server system 120 and clicks a link to view a job listing for a job they are interested in from server system 120. In response, the client system 102 receives the requested job listing data (e.g., data describing the position, the associated organization, the job requirements, and responsibilities) and displays that data in a user interface on the client system 102.

In some example embodiments, as shown in FIG. 1, the server system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a server system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the various example embodiments are by no means limited to this architecture.

As shown in FIG. 1, the front end consists of a user interface module (e.g., a web server) 122, which receives requests from various client systems 102 and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser 106 applications or applications that have been developed for a specific platform to include any of a wide variety of mobile devices and operating systems.

As shown in FIG. 1, the data layer includes several databases, including databases for storing data for various members of the server system 120, including member profile data 130, skill data 132 (e.g., data describing the skills of one or more members of the server system 120), course data 134 (e.g., data describing one or more available courses or other skill learning materials including videos), course skill data 136 (e.g., data describing which skills or skill clusters are taught in each of the one or more courses stored in the course data 134), and social graph data 138, which is data stored in a particular type of database that uses graph structures with nodes, edges, and properties to represent and store data. Of course, with various alternative example embodiments, any number of other entities might be included in the social graph (e.g., companies, organizations, schools and universities, religious groups, non-profit organizations, governmental organizations, non-government organizations (NGOs), and any other group) and, as such, various other databases may be used to store data corresponding with other entities.

Consistent with some example embodiments, when a person initially registers to become a member of the server system 120, the person will be prompted to provide some personal information, such as his or her name, age (e.g., birth date), gender, contact information, home town, address, educational background (e.g., schools, majors, etc.), current job title, job description, industry, employment history, skills, professional organizations, memberships with other online service systems, and so on. This information is stored, for example, in the member profile data 130.

In some example embodiments, the member profile data 130 includes skill data 132. In other example embodiments, the member skill database 132 is distinct from, but associated with, the member profile database 130. The member skill database 132 stores skill data for each member of the server system (e.g., system 120 in FIG. 1). Skills stored in the member skill database 132 include both explicit skills and implicit skills.

In some example embodiments, explicit skills are skills that the member is determined to have based on skill information directly received from the member. For example, a member reports that they have skills in using the C++, Java, PHP, CSS, and Python programming languages. Because the member directly reported these skills they are considered explicit skills. In some example embodiments, explicit skills are listed on a member's public profile.

In some example embodiments, one or more skills are determined based on an analysis of the non-skill data stored in a member profile. Skills determined in this way are considered implicit skills. Implicit skills are determined or inferred by analyzing data stored in a member profile, including but not limited to education, job history, hobbies, friends, skill ratings, interests, projects a member has worked on, activity on the server system (e.g., system 120 in FIG. 1), and member submitted comments. In some example embodiments, implicit skills may also be called inferred skills or skills a member may have. For example, member A lists an undergraduate degree in architecture and has a past job history that includes holding the title of Project Architect for at least three different projects. The system 120 determines that member A has skill in AutoCAD even though the member has not directly reported having that skill. In some example embodiments, implicit skills are not listed on a member's public profile.

The course data 134 includes a listing of all available training materials or courses available through the server system 120. In some example embodiments, each course is a series of videos demonstrating or explaining skills and concepts associated with a particular topic or skill. For example, a course on Java programming includes video, audio, web-based, or written materials that explain concepts related to Java programming and demonstrate those skills. In some example embodiments, the course materials also include one or more interactive learning opportunities.

The course skill data 136 includes a listing of which skills or skill clusters are taught by which course or training material. In some example embodiments, the skills associated with particular courses are determined when a course is created. For example, the user who creates a course can list the skills or skills groups taught by the course. In other example embodiments, the content of a course is analyzed to determine which skills are taught by the course.

Once registered, a member may invite other members, or be invited by other members, to connect via the network service. A “connection” may include a bi-lateral agreement by the members, such that both members acknowledge the establishment of the connection. Similarly, with some example embodiments, a member may elect to “follow” another member. In contrast to establishing a “connection,” the concept of “following” another member typically is a unilateral operation and, at least with some example embodiments, does not include acknowledgement or approval by the member that is being followed. When one member follows another, the member who is following may receive automatic notifications about various interactions undertaken by the member being followed. In addition to following another member, a member may elect to follow a company, a topic, a conversation, or some other entity, which may or may not be included in the social graph. Various other types of relationships may exist between different entities and are represented in the social graph data 138.

The server system 120 may provide a broad range of other applications and services that allow members the opportunity to share and receive information, often customized to the interests of the member. In some example embodiments, the server system 120 may include a photo sharing application that allows members to upload and share photos with other members. As such, at least with some example embodiments, a photograph may be a property or entity included within a social graph. With some example embodiments, members of a server system 120 may be able to self-organize into groups, or interest groups, organized around a subject matter or topic of interest. In some example embodiments, the data for a group may be stored in a database. When a member joins a group, his or her membership in the group will be reflected in the member profile data 130 and the social graph data 138.

In some example embodiments, the application logic layer includes various application server modules, which, in conjunction with the user interface module(s) 122, generate various user interfaces (e.g., web pages) with data retrieved from various data sources in the data layer. With some example embodiments, individual application server modules are used to implement the functionality associated with various applications, services, and features of the server service. For instance, a messaging application, such as an email application, an instant messaging application, or some hybrid or variation of the two, may be implemented with one or more application server modules. Similarly, a search engine enabling members to search for and browse member profiles may be implemented with one or more application server modules. An interest determination module 124 or a scoring module 126 can also be included in the application logic layer. Of course, other applications or services that utilize the interest determination module 124 or the scoring module 126 may be separately implemented in their own application server modules.

As illustrated in FIG. 1, with some example embodiments, the interest determination module 124 or the scoring module 126 are implemented as services that operate in conjunction with various application server modules. For instance, any number of individual application server modules can invoke the functionality of the interest determination module 124 or the scoring module 126. However, with various alternative example embodiments, the interest determination module 124 or the scoring module 126 may be implemented as their own application server modules such that they operate as stand-alone applications.

Generally, the interest determination module 124 is accessed when evaluating the amount of interest in leaning a particular skill or skill cluster. In some example embodiments, both member interest (e.g., interest as determined based on member actions and data) and potential employer interest (e.g., interest from potential employers in hiring members with the skill or skill cluster.).

In some example embodiments, the interest determination module 124 first determines employer interest by evaluating a plurality of job listings that are currently available. The interest determination module 124 analyzes the text of the job listings and, based on which skills are required, determines a frequency that each skill or skill cluster is required. In some example embodiments, each skill can be ranked based on how often it is required.

The interest determination module 124 can also determine, for each skill or skill cluster, how many members already have that skill. In some example embodiments, the number of members who have a skill can be represented as a percentage of all members or all members in a particular field. In some example embodiments, the interest determination module 124 compares the number of members who have a particular skill with how commonly that skill is required by job listings. For example, skills that are required by a large number of open job listings but are not very common among the members of the server system 120 are determined to be more highly in demand than skills that are commonly held by members of the server system 120.

In some example embodiments, the interest determination module 124 also analyzes data regarding recent job changes among the members of the server system 120. In some example embodiments, the interest determination module 124 determines the volume of new hires who have a particular skill or skill cluster. This is then compared to the number of jobs that require the skill and the number of members that have the skill.

In some example embodiments, the interest determination module 124 also determines the amount of search volume for keywords associated with each skill. In some example embodiments, skills associated with keywords that have higher than average search volume can be determined to be in demand.

In some example embodiments, the interest determination module 124 also determines the number of courses or other learning material that teach each skill in the list of skills.

In some example embodiments, the scoring module 126 uses the determined demand for each skill and the determined supply for each skill to generate a content priority score for each skill. In some example embodiments, the content priority skill can then be used to generate recommendations as to what content would be most beneficial to add to the course data 134.

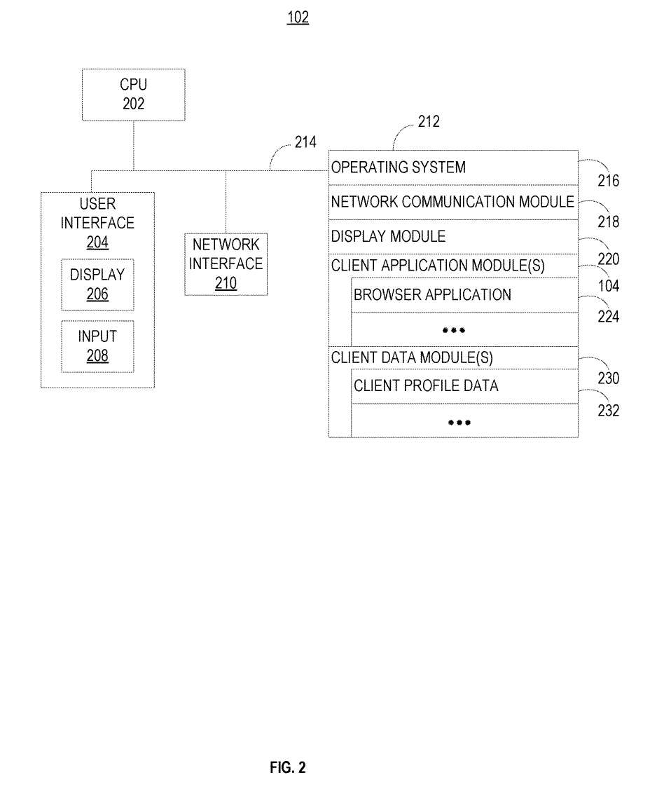

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means such as a keyboard, mouse, a touch sensitive display, or other input buttons 208. Furthermore, some client systems 102 use a microphone and voice recognition to supplement or replace the keyboard.

Memory 212 includes high-speed random access memory, such as dynamic random-access memory (DRAM), static random access memory (SRAM), double data rate random access memory (DDR RAM) or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. memory 212, or alternately, the non-volatile memory device(s) within memory 212, comprise(s) a non-transitory computer-readable storage medium.

In some example embodiments, memory 212, or the computer-readable storage medium of memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more communication network interfaces 210 (wired or wireless) and one or more communication networks 110, such as the Internet, other, LANs, metropolitan area networks (MANs), etc.;
a display module 220 for enabling the information generated by the operating system 216 and client application(s) 104 to be presented visually on the display device 206;
one or more client applications 104 for handling various aspects of interacting with the server system 120 (FIG. 1), including but not limited to:
   a browser application 224 for requesting information from the server system 120 (e.g., job listings) and receiving responses from the server system 120; and
client data module(s) 230 for storing data relevant to the clients, including but not limited to:
   client profile data 232 for storing profile data related to a member of the server system 120 associated with the client system 102.

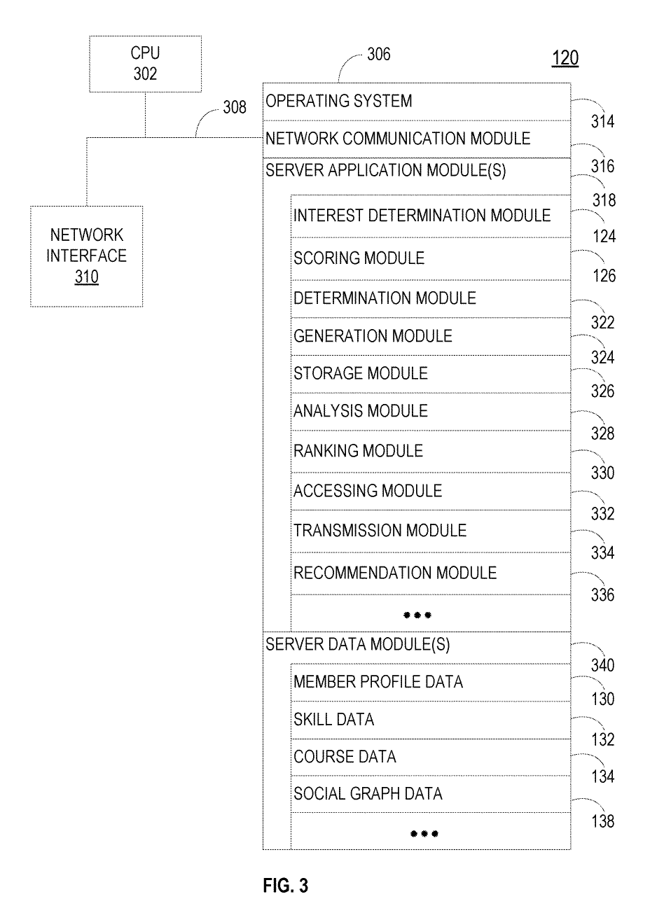

FIG. 3 is a block diagram further illustrating the server system 120, in accordance with some example embodiments. Thus, FIG. 3 is an example embodiment of the server system 120 in FIG. 1. The server system 120 typically includes one or more CPUs 302, one or more network interfaces 310, memory 306, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer-readable storage medium. In some example embodiments, memory 306, or the computer-readable storage medium of memory 306, stores the following programs, modules, and data structures, or a subset thereof:
an operating system 314 that includes procedures for handling various basic system services and for performing hardware-dependent tasks;
a network communication module 316 that is used for connecting the server system 120 to other computers via the one or more communication network interfaces 310 (wired or wireless) and one or more communication network 110, such as the Internet, other WANs, LANs, MANs, and so on;
one or more server application modules 318 for performing the services offered by the server system 120, including but not limited to:
   an interest determination module 124 for determining, for a particular skill, the amount of interest that members and employers have in the particular skill based on job listings, search volumes, new job records, members skill data 132, and so on;
   a scoring module 126 for generating a content priority score for a particular skill based on the determined user interest in a skill and the number of currently available courses that teach the particular skill;
   a determination module 322 for determining, for a particular skill, a member interest score for the particular skill, an employer interest score in the particular skill, a number of skill learning materials for the particular skill, the number of members that have the particular skill, keywords associated with the skill, and so on;
   a generation module 324 for generating a content priority score for one or more skills based on determined interest in the skill and the currently available supply of courses;
      a storage module 326 for storing member skill data 132 and course data 134;
   an analysis module 328 for analyzing the text of a plurality of job listings to determine one or more skills required by the job listing;
   a ranking module 330 for ordering skills based on their determined content priority scores, such that the skills with the highest content priority scores will be ranked the highest;
   an accessing module 332 for accessing search records to determine search volume for particular keywords during a particular time frame;
   a transmission module 334 for transmitting a content creation recommendation to a content creation system based on one or more skill rankings; and
   a recommendation module 336 for determining one or more skills to recommend for additional course content based on determined content priority scores; and
server data module(s) 340, holding data related to server system 120, including but not limited to:
   member profile data 130 including both data provided by the member who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on the member's activity, social graph data 138, overall trend data for the server system 120, and so on;
   skill data 132 including data representing a member's stated or inferred skills;
   course data 134 including data describing one or more courses offered by the server system 120 include the name of the course, the type of content, the skills that are taught by the course, any course requirements, and so on; and
   social graph data 138 including data that represents members of the server system 120 and the social connections between them.

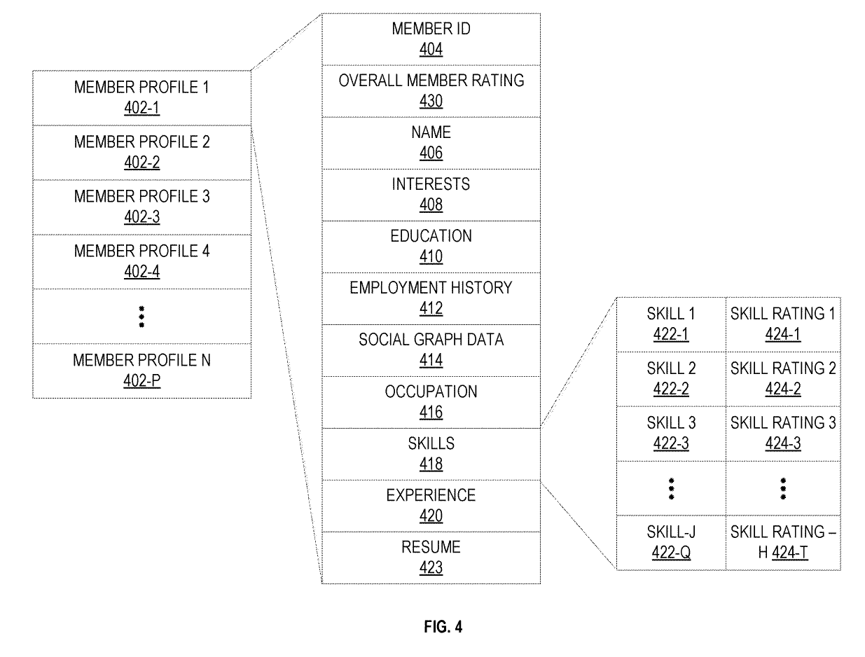

FIG. 4 depicts a block diagram of an exemplary data structure for the member profile data 130 for storing member profiles, in accordance with some example embodiments. In accordance with some example embodiments, the member profile data 130 includes a plurality of member profiles 402-1 to 402-P, each of which corresponds to a member of the server system (FIG. 1, 120).

In some example embodiments, a respective member profile 402 stores a unique member ID 404 for the member profile 402, the overall member rating 430 for the member, a name 406 for the member (e.g., the member's legal name), member interests 408, member education history 410 (e.g., the high school and universities the member attended and the subjects studied), employment history 412 (e.g., member's past and present work history with job titles), social graph data 414 (e.g., a listing of the member's relationships as tracked by the social network system (FIG. 1, 120)), occupation 416, skills 418, experience 420 (for listing experiences that do not fit under other categories like community service or serving on the board of a professional organization), and a detailed member resume 423.

In some example embodiments, a member profile 402 includes a list of skills (422-1 to 422-Q) and associated skill ratings (424-1 to 424-T). Each skill 422 represents a skill or ability that the member associated with the member profile 402 has. For example, a computer programmer might list FORTRAN as a skill 422. In addition, each skill 422 has an associated skill rating 424. In some example embodiments, a skill rating 424 represents the server system's (FIG. 1, 120) estimation of the member's proficiency in a skill 422. For example, the skill rating 242 could be a number from 1 to 100 wherein 100 is the highest skill rating 242 and 1 is the lowest. Thus a member who had AutoCAD with a skill rating 424 of 25 would be less proficient using AutoCAD than a member with a skill rating 424 of 78. In some example embodiments, an overall member rating 430 is generated based on feedback from other members (e.g., recommendations or endorsements) and based on the information stored in the member profile 402 associated with the member.

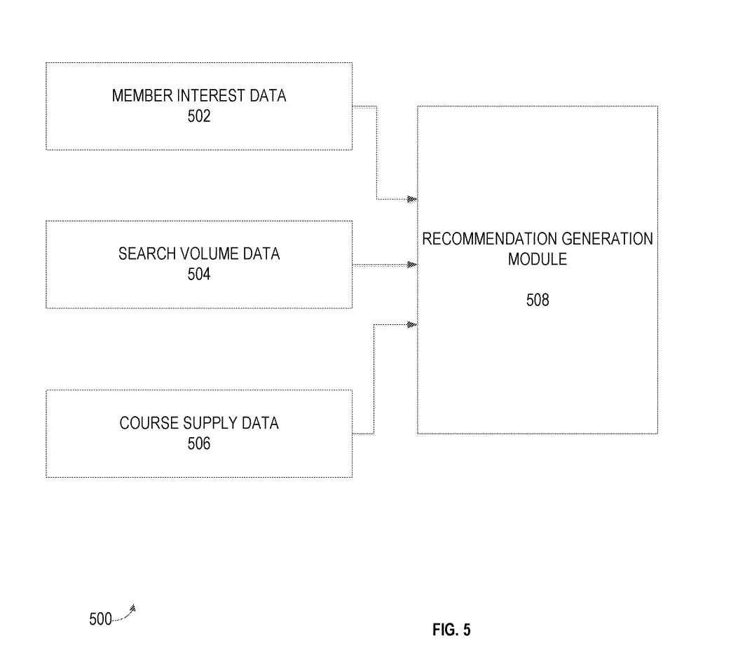

FIG. 5 is a block diagram illustrating a system for generating content generation recommendations based on a demand and supply analysis of skills 422.

In some example embodiments, a server system (e.g., the server system 120 in FIG. 1) collects member interest data 502. In some example embodiments, member interest data 502 is any data that reflects potential member interest in learning a particular skill 422 in the set of skills 422.

In some example embodiments, member interest data 502 includes data describing the amount of members that already have a given skill 422. In some example embodiments, this is determined based on an analysis of the member profiles 402. In general, skills 422 that are already possessed by a large number of members are less likely to be in high demand than skills 422 possessed by a relatively small number of members.

In some example embodiments, member interest data 502 reflects the number of job listings that require the skill 422. In some example embodiments, the server system (e.g., the server system 120 in FIG. 1) parses a plurality of job listings and determines which skills 422 are necessary to meet the listed job requirements. In some example embodiments, the server system (e.g., the server system 120 in FIG. 1) determines which skills 422 are most likely to be required by the job listings.

In some example embodiments, the member interest data 502 is determined based on new job placement data. In some example embodiments, the server system (e.g., the server system 120 in FIG. 1) determines the number of new hires for jobs requiring a particular skill 422 and calculates a ratio against total members who have the particular skill 422. For example, if a large number of the total members who have a particular skill 422 have started new jobs in the last three months, the server system (e.g., the server system 120 in FIG. 1) determines the particular skill 422 is more in demand than a skill 422 where fewer of the members possessing that skill 422 have recently started a new job.

In some example embodiments, the server system (e.g., the server system 120 in FIG. 1) accesses a database of stored search information. In some example embodiments, the database of stored search information is available either publicly or with a subscription fee. In some example embodiments, a publicly available database stores all search queries issued by users of a particular search engine over a long period of time.

The server system (e.g., the server system 120 in FIG. 1) then determines one or more search terms associated with each skill 422 (or with learning each skill 422). In some example embodiments, the server system (e.g., the server system 120 in FIG. 1) maintains a list of skills and terms associated with those skills. For example, the skill of building planning might include the term “AutoCAD” or the skill front end web-design might include the term “CSS.”

In other example embodiments, server system (e.g., the server system 120 in FIG. 1) track what search terms lead users to information about certain skills. For example, the server system (e.g., the server system 120 in FIG. 1) tracks what percentage of users who search for “MySQL” select search results associated with the skill of database programming. If search results associated with the skill of database programming make up the most commonly selected search results, the server system (e.g., the server system 120 in FIG. 1) can associated “MySQL” with the skill of database programming.

Once the search terms have been identified, the server system (e.g., the server system 120 in FIG. 1) determines the search volume for those one or more terms. The server system (e.g., the server system 120 in FIG. 1) can then estimate a particular skill's 422 popularity based on the search volume for terms associated with that skill 422.

In some example embodiments, the server system (e.g., the server system 120 in FIG. 1) determines the number of courses available for the particular skills 422 by analyzing the course supply data 506. In some example embodiments, the course supply data 506 includes data describing the content, availability, requirements, and cost (if applicable) of each course. The server system (e.g., the server system 120 in FIG. 1) uses the content data associated with each course to determine which skills 422 or skill clusters the course teaches. Using this data, the server system (e.g., the server system 120 in FIG. 1) can determine, for each skill 422, the total number of courses that teach that skill 422.

In some example embodiments, the recommendation generation module 508 uses both demand information (e.g., member interest data 502 and search volume data 504) and supply information (e.g., course supply data 506) to determine an overall content priority score, wherein the content priority score represents the degree that demand outpaces current supply.

In some example embodiments, the recommendation generation module 508 ranks the skills 422 based on their content priority score. In some example embodiments, the recommendation generation module 508 selects one or more skills 422 based on the rankings to recommend for additional content generation (e.g., more courses).

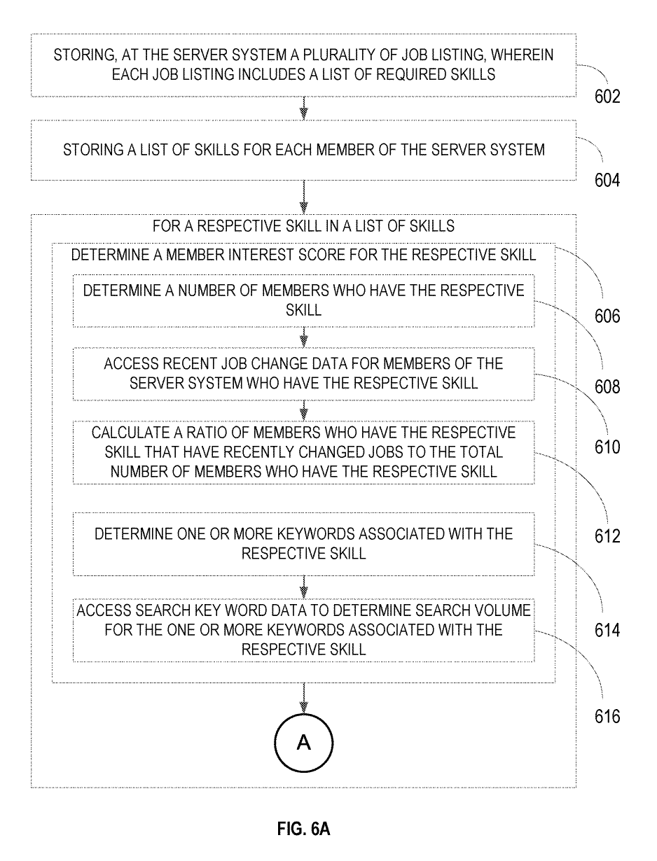

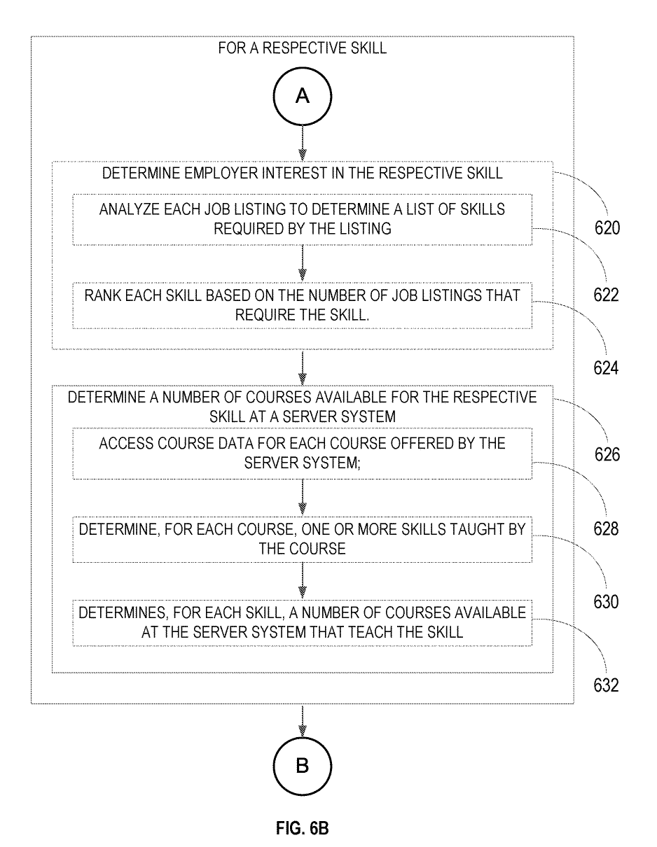

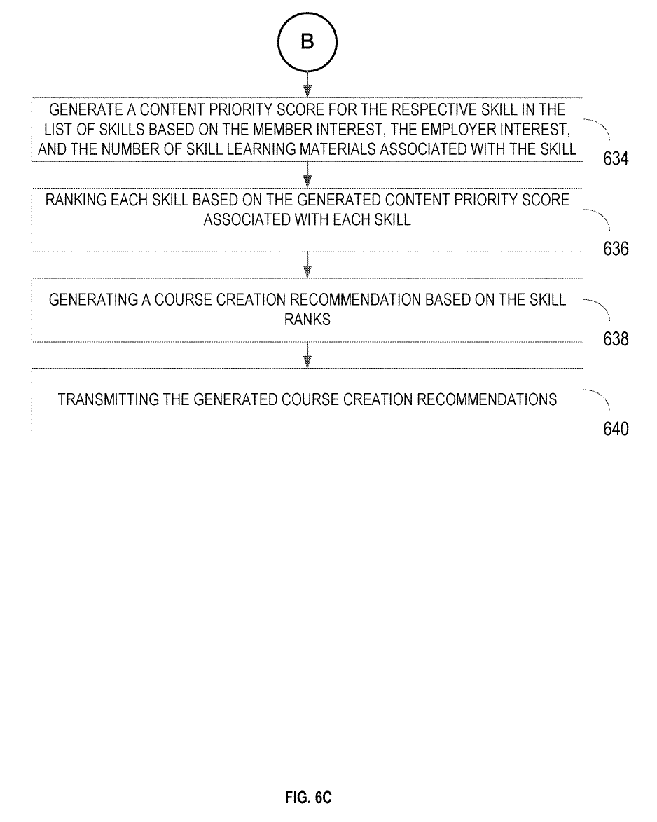

FIG. 6A is a flow diagram illustrating a method, in accordance with some example embodiments, for generating content generation recommendations based on a demand and supply analysis of skills 422. Each of the operations shown in FIG. 6A may correspond to instructions stored in a computer memory 212 or computer-readable storage medium. Optional operations are indicated by dashed lines (e.g., boxes with dashed-line borders). In some embodiments, the method described in FIG. 6A is performed by the server system (e.g., the server system 120 in FIG. 1). However, the method described can also be performed by any other suitable configuration of electronic hardware.

In some embodiments, the method is performed at a server system (e.g., the server system 120 in FIG. 1) including one or more processors and memory 212 storing one or more programs for execution by the one or more processors.

In some example embodiments, the server system (e.g., the server system 120 in FIG. 1) stores (602), in a database, a plurality of job listings. Each job listing includes information about the job, such as the employer, the location of the job, the responsibilities associated with the job, the pay or salary associated with the job, and so on. In some example embodiments, by analyzing the requirements listed in the job listing, the server system (e.g., the server system 120 in FIG. 1) can generate or access a list of required skills 422 associated with the job. In some example embodiments, the list of required skills 422 comprises the skills 422 a member will need to be a good candidate for the job.

In some example embodiments, the server system (e.g., the server system 120 in FIG. 1) stores (604) a list of skills 422 for each member of the server system 120. For example, each member has a member profile 402. The member profile 402 includes information about that member that is either submitted by the member, other members of the server system (e.g., the server system 120 in FIG. 1), or determined based on analysis of the members submitted data or activity. Thus, a member can submit a list of skills 422 that the member has or the server system (e.g., the server system 120 in FIG. 1) can determine, based on a members education history and job history, one or more skills 422 the member is likely to have.

In some example embodiments, for a respective skill 422 in a list of skills 422, the server system (e.g., the server system 120 in FIG. 1) determines (606) a member interest score for the respective skill 422.

Determining a member interest score for the respective skill 422 includes the server system (e.g., the server system 120 in FIG. 1) determining (608) a number of members who have the respective skill 422. The server system (e.g., the server system 120 in FIG. 1) accesses the list of skills 422 for each member based on the skills 422 stored in the member profile 402.

In some example embodiments, the server system (e.g., the server system 120 in FIG. 1) accesses (610) recent job change data for members of the server system (e.g., the server system 120 in FIG. 1) who have the respective skill 422.

In some example embodiments, the server system (e.g., the server system 120 in FIG. 1) calculates (612) a ratio of members who have the respective skill 422 that have recently changed jobs to the total number of members who have the respective skill 422.

In some example embodiments, the ratio also includes the number of jobs that require the respective skill 422 as follows:

$$\frac{number of new hires that have the resprective skill}{\begin{matrix}jobs requiring the respective skill + \\ total members that have the respective skill\end{matrix}}$$

In some example embodiments, the calculated ratio serves as the member interest score. In some example embodiments, the skills 422 can be ranked based on the determined member interests score to identify the one or more skills 422 that are the most in demand from members.

In some example embodiments, for each respective skill 422, the server system (e.g., the server system 120 in FIG. 1) determines (614) one or more keywords associated with the respective skill 422. In some example embodiments, if the skill 422 is front-end web site design, the determined keywords could include “CSS reference.” In some example embodiments, the keywords are predetermined. In other example embodiments, the server system (e.g., the server system 120 in FIG. 1) analyzes the text associated with skills 422 to determine one or more keywords.

In some example embodiments, the server system (e.g., the server system 120 in FIG. 1) accesses (616) search key word data to determine search volume for the one or more keywords associated with the respective skill 422. In some example embodiments, the search data is accessed from a publicly available database of search data.

FIG. 6B is a flow diagram illustrating a method, in accordance with some example embodiments, for generating content generation recommendations based on a demand and supply analysis of skills 422. Each of the operations shown in FIG. 6B may correspond to instructions stored in a computer memory 212 or computer-readable storage medium. Optional operations are indicated by dashed lines (e.g., boxes with dashed-line borders). In some embodiments, the method described in FIG. 6B is performed by the server system (e.g., the server system 120 in FIG. 1). However, the method described can also be performed by any other suitable configuration of electronic hardware.

In some embodiments, the method is performed at a server system (e.g., the server system 120 in FIG. 1) including one or more processors and memory 212 storing one or more programs for execution by the one or more processors.

In some example embodiments, the server system (e.g., the server system 120 in FIG. 1) determines (620) employer interest in the respective skill 422. In some example embodiments, the employer interest is a representation of the degree to which prospective employers want employees with the respective skill 422.

In some example embodiments, employer interest is associated with the ratio of all job listings that require the respective skill to the total number of job listings. For example, if there are 500 job listings that require Skill A and 200 job listings that require Skill B, with 3000 total job listings, Skill A will have a higher employer interest score than Skill B.

In some example embodiments, the server system (e.g., the server system 120 in FIG. 1) analyzes (622) each job listing to determine a list of skills 422 required by the listing. For example, the server system (e.g., the server system 120 in FIG. 1) parses the list of requirements in a job listing and identifies one or more skills 422. The server system (e.g., the server system 120 in FIG. 1) then totals the number of job listings that require each skill 422.

In some example embodiments, for each respective skill 422 in the list of skills 422, the server system (e.g., the server system 120 in FIG. 1) ranks (624) each skill 422 based on the number of job listings that require the skill 422. Thus, the skills 422 that are required by the most job listings can be identified.

In some example embodiments, the server system (e.g., the server system 120 in FIG. 1) determines (626) a number of courses available for the respective skill 422 at a server system (e.g., the server system 120 in FIG. 1).

In some example embodiments, the server system (e.g., the server system 120 in FIG. 1) accesses (628) course data 134 for each course offered by the server system (e.g., the server system 120 in FIG. 1). The server system (e.g., the server system 120 in FIG. 1) then determines (630), for each course, one or more skills 422 taught by the course.

In some example embodiments, the server system (e.g., the server system 120 in FIG. 1) determines (632), for each skill 422, a number of courses available at the server system 120 that teach the skill 422. The server system (e.g., the server system 120 in FIG. 1) can then determine, for each skill 422, the number of courses (or other educational material) that teach that skill 422.

FIG. 6C is a flow diagram illustrating a method, in accordance with some example embodiments, for generating content generation recommendations based on a demand and supply analysis of skills 422. Each of the operations shown in FIG. 6C may correspond to instructions stored in a computer memory 212 or computer-readable storage medium. In some embodiments, the method described in FIG. 6C is performed by the server system (e.g., the server system 120 in FIG. 1). However, the method described can also be performed by any other suitable configuration of electronic hardware.

In some embodiments, the method is performed at a server system (e.g., the server system 120 in FIG. 1) including one or more processors and memory 212 storing one or more programs for execution by the one or more processors.

In some example embodiments, the server system (e.g., the server system 120 in FIG. 1) generates (634) a content priority score for the respective skill 422 in the list of skills 422 based on the member interest, the employer interest, and the number of skill learning materials associated with the skill 422.

In some example embodiments, generating a content priority score for a particular skill 422 includes determining the current member interest score and determining an employer interest score. The server system (e.g., the server system 120 in FIG. 1) also determines a search volume score, which represents how often users conduct searches related to that skill. The employer interest score, member interest score, and search volume score are added together to represent aggregate demand score.

The server system (e.g., the server system 120 in FIG. 1) then subtracts a value representing the number of currently existing courses for the particular skill 422 from the aggregate demand score to generate the content priority score.

In some example embodiments, the server system (e.g., the server system 120 in FIG. 1) ranks (636) each skill 422 based on the generated content priority score associated with each skill 422, such that most important skills 422 are ranked the highest.

In some example embodiments, the server system (e.g., the server system 120 in FIG. 1) generates (638) a course creation recommendation based on the skill rank. The server system (e.g., the server system 120 in FIG. 1) transmits (640) the generated course creation recommendations to a content creation system. In some example embodiments, the recommendation is received by an employee of the server system (e.g., the server system 120 in FIG. 1) and in response the employee initiates creation of new course content.

### Software Architecture

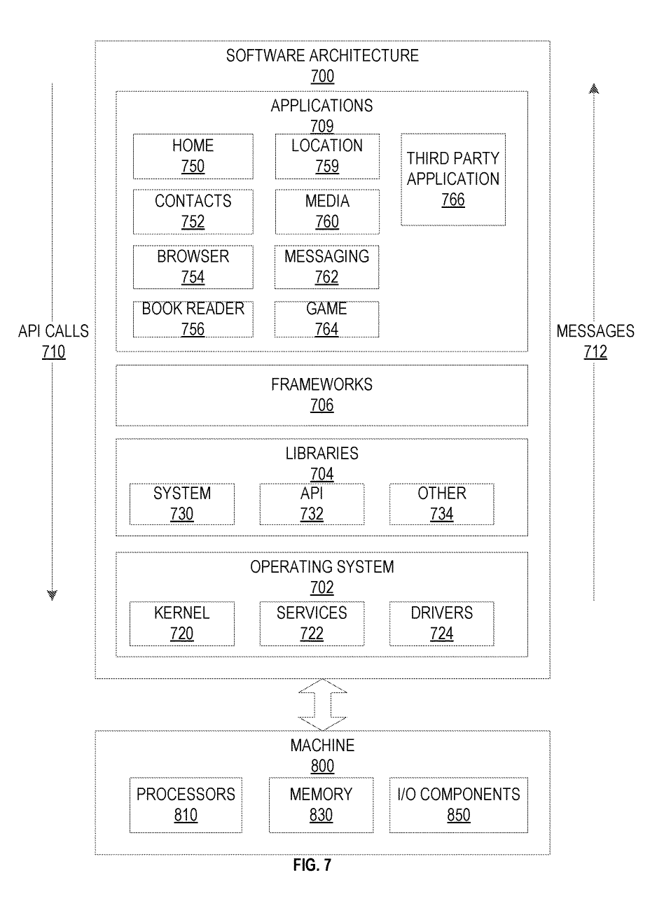

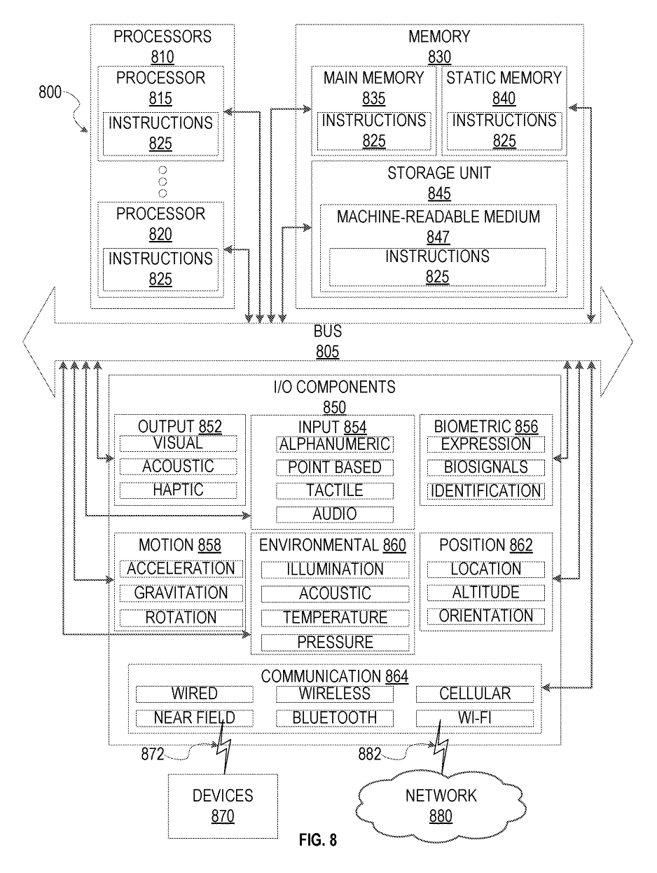

FIG. 7 is a block diagram illustrating an architecture of software 700, which may be installed on any one or more of the devices of FIG. 1. FIG. 7 is merely a non-limiting example of an architecture of software 700 and it will be appreciated that many other architectures may be implemented to facilitate the functionality described herein. The software 700 may be executing on hardware such as a machine 800 of FIG. 8 that includes processors 810, memory 830, and I/O components 850. In the example architecture of FIG. 7, the software 700 may be conceptualized as a stack of layers where each layer may provide particular functionality. For example, the software 700 may include layers such as an operating system 702, libraries 704, frameworks 706, and applications 709. Operationally, the applications 709 may invoke API calls 710 through the software stack and receive messages 712 in response to the API calls 710.

The operating system 702 may manage hardware resources and provide common services. The operating system 702 may include, for example, a kernel 720, services 722, and drivers 724. The kernel 720 may act as an abstraction layer between the hardware and the other software layers. For example, the kernel 720 may be responsible for memory management, processor management (e.g., scheduling), component management, networking, security settings, and so on. The services 722 may provide other common services for the other software layers. The drivers 724 may be responsible for controlling and/or interfacing with the underlying hardware. For instance, the drivers 724 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 704 may provide a low-level common infrastructure that may be utilized by the applications 709. The libraries 704 may include system libraries 730 (e.g., C standard library) that may provide functions such as memory allocation functions, string manipulation functions, mathematic functions, and the like. In addition, the libraries 704 may include API libraries 732 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 704 may also include a wide variety of other libraries 734 to provide many other APIs to the applications 709.

The frameworks 706 may provide a high-level common infrastructure that may be utilized by the applications 709. For example, the frameworks 706 may provide various graphical user interface (GUI) functions, high-level resource management, high-level location services, and so forth. The frameworks 706 may provide a broad spectrum of other APIs that may be utilized by the applications 709, some of which may be specific to a particular operating system 702 or platform.

The applications 709 include a home application 750, a contacts application 752, a browser application 754, a book reader application 756, a location application 759, a media application 760, a messaging application 762, a game application 764, and a broad assortment of other applications such as a third party application 766. In a specific example, the third party application 766 (e.g., an application developed using the Android™ or iOS™ software development kit (SDK) by an entity other than the vendor of the particular platform) may be mobile software running on a mobile operating system 702 such as iOS™, Android™ Windows® Phone, or other mobile operating systems 702. In this example, the third party application 766 may invoke the API calls 710 provided by the mobile operating system 702 to facilitate functionality described herein.

### Example Machine Architecture and Machine-Readable Medium

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 825 (e.g., software, a program, an application, an applet, an app, or other executable code for causing the machine 800 to perform any one or more of the methodologies discussed herein) may be executed. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but be not limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 825, sequentially or otherwise, that specify actions to be taken by the machine 800. Further, while only a single machine 800 is illustrated, the term “machine” shall also be taken to include a collection of machines 800 that individually or jointly execute the instructions 825 to perform any one or more of the methodologies discussed herein.

The machine 800 may include processors 810, memory 830, and I/O components 850, which may be configured to communicate with each other via a bus 805. In an example embodiment, the processors 810 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 815 and a processor 820, which may execute the instructions 825. The term “processor” is intended to include multi-core processors 810 that may comprise two or more independent processors 815, 820 (also referred to as “cores”) that may execute the instructions 825 contemporaneously. Although FIG. 8 shows multiple processors 810, the machine 800 may include a single processor 810 with a single core, a single processor 810 with multiple cores (e.g., a multi-core processor), multiple processors 810 with a single core, multiple processors 810 with multiple cores, or any combination thereof.

The memory 830 may include a main memory 835, a static memory 840, and a storage unit 845 accessible to the processors 810 via the bus 805. The storage unit 845 may include a machine-readable medium 847 on which are stored the instructions 825 embodying any one or more of the methodologies or functions described herein. The instructions 825 may also reside, completely or at least partially, within the main memory 835, within the static memory 840, within at least one of the processors 810 (e.g., within the processor's cache memory), or any suitable combination thereof, during execution thereof by the machine 800. Accordingly, the main memory 835, the static memory 840, and the processors 810 may be considered machine-readable media 847.

As used herein, the term “memory” refers to a machine-readable medium 847 able to store data temporarily or permanently and may be taken to include, but not be limited to, random-access memory (RAM), read-only memory (ROM), buffer memory, flash memory, and cache memory. While the machine-readable medium 847 is shown, in an example embodiment, to be a single medium, the term “machine-readable medium” should be taken to include a single medium or multiple media (e.g., a centralized or distributed database, or associated caches and servers) able to store the instructions 825. The term “machine-readable medium” shall also be taken to include any medium, or combination of multiple media, that is capable of storing instructions (e.g., instructions 825) for execution by a machine (e.g., machine 800), such that the instructions 825, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 850 may include a wide variety of components to receive input, provide and/or produce output, transmit information, exchange information, capture measurements, and so on. It will be appreciated that the I/O components 850 may include many other components that are not shown in FIG. 8. In various example embodiments, the I/O components 850 may include output components 852 and/or input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 850 may include biometric components 856, motion components 858, environmental components 860, and/or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 862 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 and/or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine 800 and/or any of a wide variety of peripheral devices (e.g., a peripheral device coupled via a USB).

Moreover, the communication components 864 may detect identifiers and/or include components operable to detect identifiers. For example, the communication components 864 may include radio frequency identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In addition, a variety of information may be derived via the communication components 864 such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 880 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 825 may be transmitted and/or received over the network 880 using a transmission medium via a network interface device (e.g., a network interface component included in the communication components 864) and utilizing any one of a number of well-known transfer protocols (e.g., HyperText Transfer Protocol (HTTP)) Similarly, the instructions 825 may be transmitted and/or received using a transmission medium via the coupling 872 (e.g., a peer-to-peer coupling) to the devices 870. The term “transmission medium” shall be taken to include any intangible medium that is capable of storing, encoding, or carrying the instructions 825 for execution by the machine 800, and includes digital or analog communications signals or other intangible media to facilitate communication of such software.

Furthermore, the machine-readable medium 847 is non-transitory (in other words, not having any transitory signals) in that it does not embody a propagating signal. However, labeling the machine-readable medium 847 as “non-transitory” should not be construed to mean that the medium is incapable of movement; the medium should be considered as being transportable from one physical location to another. Additionally, since the machine-readable medium 847 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended claims, the singular forms “a,” “an,” and “the” are intended to include the plural forms as well, unless the context clearly indicates otherwise. It will also be understood that the term “and/or”, as used herein, refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A computer-implemented method comprising:
using at least one computer processor to:
for a respective skill in a list of skills:
determining a member interest score in the respective skill;
determining employer interest in the respective skill; and
determining a number of courses available for the respective skill at a server system;
generating a content priority score for the respective skill in the list of skills based on the member interest, the employer interest, and the number of skill learning materials associated with the skill.

2. The method of claim 1, further comprising:
storing, at the server system, a plurality of job listings, wherein each job listing includes a list of required skills; and
wherein determining employer interest in the respective skill further comprises:
analyzing each job listing to determine the list of skills required by the listing;
for each respective skill in the list of skills: rank each skill based on the number of job listings that require the skill.

3. The method of claim 1, further comprising:
storing the list of skills for each member of the server system; and wherein determining the member interest score in the respective skill further includes:
for each respective skill in the list of skills, determining a number of members who have the respective skill.

4. The method of claim 1, wherein determining the member interest score in the respective skill further includes:
for each respective skill:
determining one or more keywords associated with the respective skill; and
accessing search key word data to determine search volume for the one or more keywords associated with the respective skill.

5. The method of claim 1, wherein determining a number of skill learning materials available at the server system further comprises:
accessing course data for each course offered by the server system;
determining, for each course, one or more skills taught by the course; and
for each skill, determining the number of courses available at the server system that teach the skill.

6. The method of claim 1, further comprising:
ranking each skill based on the generated content priority score associated with each skill.

7. The method of claim 6, further comprising:
generating a course creation recommendation based on the skill ranks; and
transmitting the generated course creation recommendations.

8. A system comprising:
one or more processors;
memory; and
one or more programs stored in the memory, the one or more programs comprising instructions for:
for a respective skill in a list of skills:
determining a member interest score in the respective skill;
determining employer interest in the respective skill; and
determining a number of courses available for the respective skill at a server system;
generating a content priority score for the respective skill in the list of skills based on the member interest, the employer interest, and the number of skill learning materials associated with the skill.

9. The system of claim 8, further comprising:
storing, at the server system, a plurality of job listings, wherein each job listing includes a list of required skills; and
wherein determining employer interest in the respective skill further comprises:
analyzing each job listing to determine the list of skills required by the listing;
for each respective skill in the list of skills: rank each skill based on the number of job listings that require the skill.

10. The system of claim 8, further comprising:
storing the list of skills for each member of the server system; and wherein determining the member interest score in the respective skill further includes:
for each respective skill in the list of skills, determining a number of members who have the respective skill.

11. The system of claim 8, wherein determining the member interest score in the respective skill further includes:
for each respective skill:
determining one or more keywords associated with the respective skill; and
accessing search key word data to determine search volume for the one or more keywords associated with the respective skill.

12. The system of claim 8, wherein determining a number of skill learning materials available at the server system further comprises:
accessing course data for each course offered by the server system;
determining, for each course, one or more skills taught by the course; and
for each skill, determining the number of courses available at the server system that teach the skill.

13. The system of claim 8, further comprising:
ranking each skill based on the generated content priority score associated with each skill.

14. The system of claim 13, further comprising:
generating a course creation recommendation based on the skill ranks; and
transmitting the generated course creation recommendations.

15. A non-transitory computer-readable storage medium storing instructions that, when executed by the one or more processors of a machine, cause the machine to perform operations comprising:
for a respective skill in a list of skills:
determining a member interest score in the respective skill;
determining employer interest in the respective skill; and
determining a number of courses available for the respective skill at a server system;
generating a content priority score for the respective skill in the list of skills based on the member interest, the employer interest, and the number of skill learning materials associated with the skill.

16. The non-transitory computer-readable storage medium of claim 15, further comprising:
storing, at the server system, a plurality of job listings, wherein each job listing includes a list of required skills; and
wherein determining employer interest in the respective skill further comprises:
analyzing each job listing to determine the list of skills required by the listing;
for each respective skill in the list of skills: rank each skill based on the number of job listings that require the skill.

17. The non-transitory computer-readable storage medium of claim 15, further comprising:
storing the list of skills for each member of the server system; and wherein determining the member interest score in the respective skill further includes:
for each respective skill in the list of skills, determining a number of members who have the respective skill.

18. The non-transitory computer-readable storage medium of claim 15, wherein determining the member interest score in the respective skill further includes:
for each respective skill:
determining one or more keywords associated with the respective skill; and
accessing search key word data to determine search volume for the one or more keywords associated with the respective skill.

19. The non-transitory computer-readable storage medium of claim 15, wherein determining a number of skill learning materials available at the server system further comprises:
accessing course data for each course offered by the server system;
determining, for each course, one or more skills taught by the course; and
for each skill, determining the number of courses available at the server system that teach the skill.

20. The non-transitory computer-readable storage medium of claim 15, further comprising:
ranking each skill based on the generated content priority score associated with each skill.
